(19) United States
(12) Patent Application Publication
(10) Pub. No.: US 2014/0036767 A1
(43) Pub. Date: Feb. 6, 2014

(54) Proximity Based Wireless Docking

(71) Applicants: Prasanth Perugupalli, Newport Beach, CA (US); Brima Ibrahim, Laguna Hills, CA (US)

(72) Inventors: Prasanth Perugupalli, Newport Beach, CA (US); Brima Ibrahim, Laguna Hills, CA (US)

(73) Assignee: BROADCOM CORPORATION, Irvine, CA (US)

(21) Appl. No.: 13/648,586

(22) Filed: Oct. 10, 2012

Related U.S. Application Data
(60) Provisional application No. 61/679,600, filed on Aug. 3, 2012.

(51) Int. Cl. H04W 4/00; H04B 7/24

(52) U.S. Cl. 370/328; 455/41.2; 455/426.1

(57) ABSTRACT

The present application discloses various implementations of a wireless docking system. In one implementation, such a wireless docking system includes a docking surface and at least one wireless transceiver configured to establish a wireless connection with a portable device. The wireless connection results in interoperability of the portable device and another device connected to the wireless docking system.

### RELATED APPLICATIONS

This application is based on and claims priority from U.S. Provisional Patent Application Ser. No. 61/679,600, filed Aug. 3, 2012, which is hereby incorporated by reference in its entirety.

### BACKGROUND

As portable communication devices such as notebooks, tablet computers, and smartphones become more powerful and versatile, they are increasingly in use as go-to computing resources by a highly mobile workforce. Despite the advantages associated with their portability and wireless connectivity, however, many popular portable devices are constrained by their size to provide limited display and user initiated input/output options. Consequently, in order for a modern portable device to be fully functional as a primary productivity platform, it should be interoperable with more traditional workstation resources such as a desktop monitor(s), Ethernet, storage devices, keyboard, and mouse.

One solution for interfacing portable devices such as netbooks or laptop computers with stationary workstation resources has been provided by docking stations that typically include physical connectors to establish a wired connection between the portable device and the workstation. As the variety of portable devices proliferates, however, and as their form factor continues to be reduced, it becomes increasingly a challenge to provide for these docking connectors on the portable device. Hence, it is increasingly desirable to provide a secure, high-throughput wireless docking solution.

### SUMMARY

The present disclosure is directed to proximity-based wireless docking, as shown in and/or described in connection with at least one of the figures, and as set forth more completely in the claims.

### BRIEF DESCRIPTION OF THE DRAWINGS

FIG. 1A shows a diagram of a workstation terminal including an exemplary wireless docking system, according to one implementation;

FIG. 1B shows a more detailed view of the exemplary wireless docking system of FIG. 1A;

FIG. 2 shows a diagram of a workstation terminal including an exemplary wireless docking system, according to another implementation;

FIG. 3 shows an exemplary integrated wireless transceiver implemented as part of a network card;

FIG. 4 shows a diagram of a network environment including work station terminals connected to exemplary wireless docking systems, according to one implementation;

FIG. 5 shows a diagram of another exemplary implementation of a wireless docking system; and

FIG. 6 is a flowchart presenting an exemplary method for performing wireless docking, according to one implementation.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

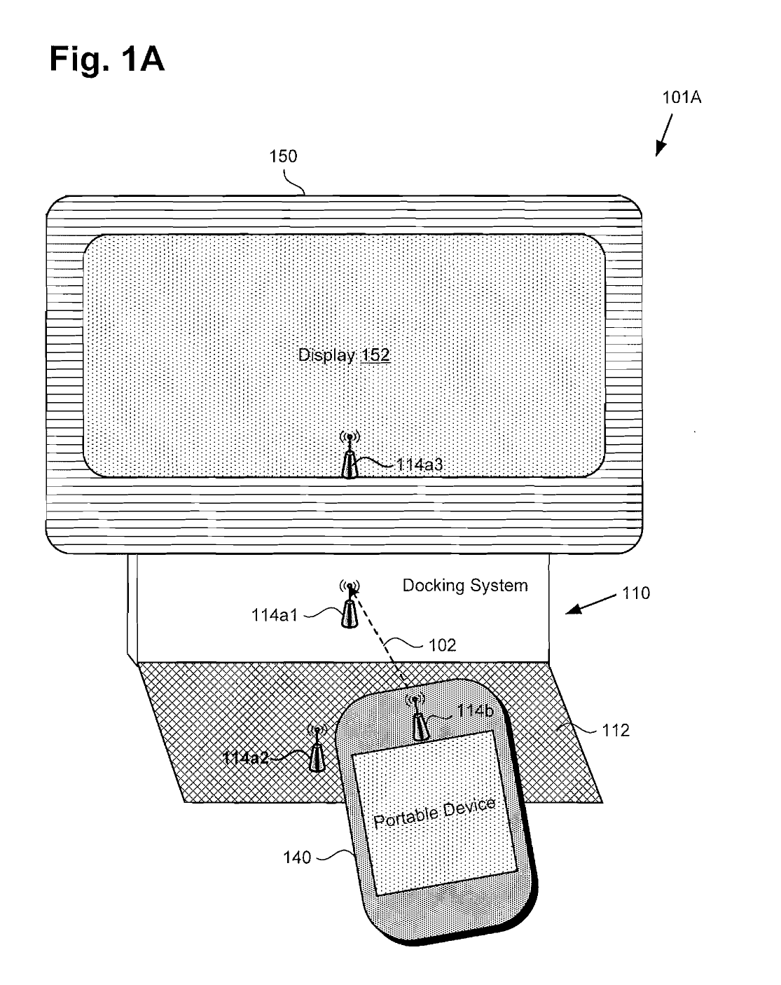

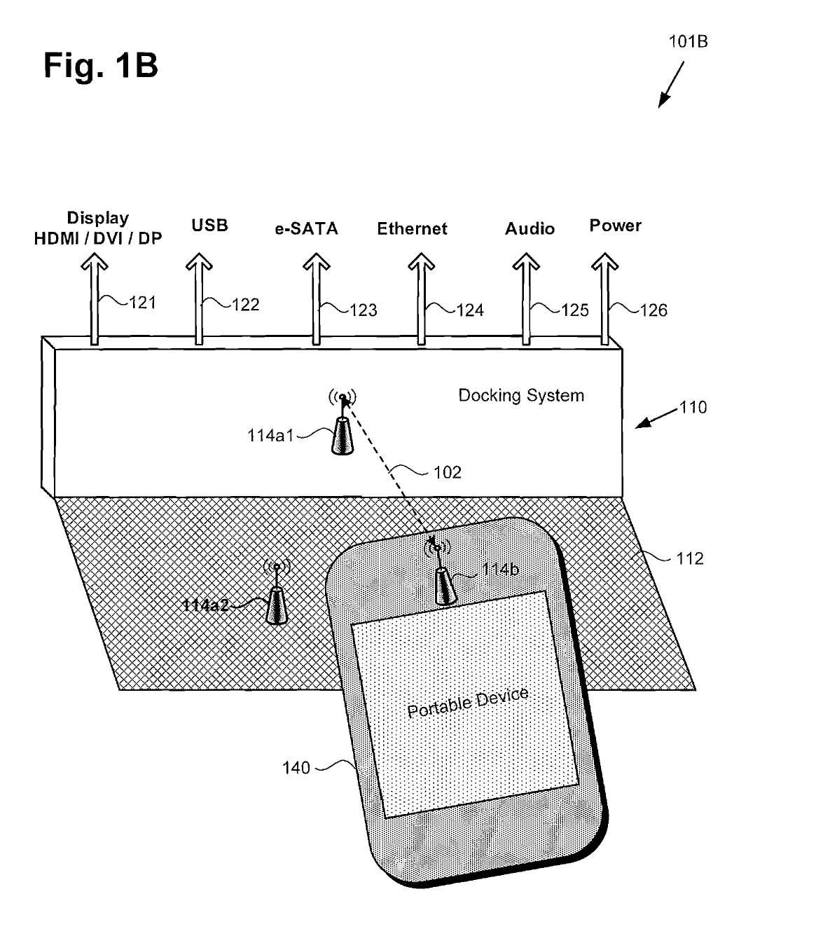

FIG. 1A shows a diagram of a workstation terminal 101A including an exemplary wireless docking system 110, according to one implementation. In addition to the wireless docking system 110, the workstation terminal 101A includes a monitor 150 providing a display 152. Also depicted in FIG. 1A is a portable device 140 including a transceiver 114b. The portable device 140 is shown to be in communication with the wireless docking system 110 via a wireless connection 102.

The wireless docking system 110 includes a docking surface 112 and wireless transceivers 114a1, 114a2, and 114a3, which, as shown in FIG. 1A, can be embedded in the docking system 110, the docking surface 112, or elsewhere on the workstation terminal 1A. For example, in one implementation, one or more of the wireless transceivers 114a1, 114a2, and 114a3 may be attached to or embedded in the monitor 150, or any other peripheral device included in the workstation terminal 101A. It is noted that although the exemplary implementation of FIG. 1 depicts multiple wireless transceivers 114a1, 114a2, and 114a3, in other implementations, the docking system 110 may include as few as one wireless transceiver, such as the wireless transceiver 114a1.

The wireless transceiver 114a1 of the wireless docking system 110 is configured to establish the wireless connection 102 with the portable device 140 based on the proximity of the portable device 140 and the docking surface 112. For example, in one implementation, establishment of a proximity-based wireless connection corresponding to wireless connection 102 may require that all or a portion of the portable device 140 be disposed on or over the docking surface 112. In one implementation, the docking surface 112 may detect that the portable device 140 is disposed on or over the docking surface 112 using a weight detector detecting the weigh applied by the portable device 140 on the docking surface 112. It is noted, however, that weight detection is merely an exemplary trigger mechanism for detection of the portable device 140 by the wireless docking system 110. In other implementations, the wireless docking system 110 can be configured to detect the presence of the portable device 140 through near field communication (NFC), or any other suitable type of wireless communication.

Although the docking surface 112 is depicted as a substantially horizontal surface such as a docking pad or mat, in other implementations, the docking surface 112 may be a vertical surface, or a surface having some other spatial orientation. In those latter implementations, establishment of a proximity-based wireless connection between the wireless docking system 110 and the portable device 140 may require that the portable device 110 make contact with or be disposed adjacent to the docking surface 112.

According to the implementation shown in FIG. 1A, establishment of the wireless connection 102 by the wireless transceiver 114a1 results in interoperability of the portable device 140 and the workstation terminal 101A. Consequently, the wireless connection 102 may result in interoperability of the portable device 140 and the monitor 150 providing the display 152.

It is noted that although not explicitly shown in FIG. 1A, the workstation terminal 101A will typically include additional devices or features connected to the wireless docking system 110. Examples of additional devices typically included in the workstation terminal 101A and connected to the wireless docking system 110 include a keyboard and mouse, a printer, and a digital scanner. In addition, the workstation terminal 110A may further include one or more additional display devices, and data storage and computing resources, such as one or more processors and memory units. Thus more generally, the wireless connection 102 results in interoperability of the portable device 140 and any other device or system, such as the workstation terminal 101A, connected to the wireless docking system 110.

In one exemplary implementation, the wireless connection 102 may enable use of the portable device 140 as an input device for the workstation terminal 101A. For example, user inputs applied to the portable device 140 could result in images corresponding to those user inputs appearing on the display 152 of the monitor 150. Consequently, in one implementation, a portable device such as a tablet computer could be wirelessly connected to the workstation terminal 101A through the wireless docking station 110 providing wireless connection 102. The tablet computer, or another instantiation of the portable device 140, could then be used to control the various devices and resources accessible through the workstation terminal 101A.

As noted above, in one implementation, the portable device 140 may be a tablet computer. Other examples of a portable device corresponding to the portable device 140 include a mobile telephone, such as a smartphone, a laptop computer, netbook, or any other kind of portable device or system utilized as a transceiver in modern electronics applications.

According to various implementations of the wireless docking system 110, the wireless transceiver 114a1, as well as the wireless transceivers 114a2 and 114a3, may be configured to establish the wireless connection 102 using any suitable radio frequency (RF) waveband. In addition, the transceivers 114a1, 114a2, and 114a3 can be configured to support any suitable communication protocol, including Bluetooth, Bluetooth LE, or WiFi.

In some implementations, however, a millimeter wavelength frequency range may be advantageous. For example, wireless connection 102 may be established using frequencies greater than 50 GHz, such as in a frequency range from approximately 57 GHz to approximately 66 GHz. The availability of bandwidth in that frequency range, as well as the higher throughput enabled by such millimeter wavelength frequencies offer substantial advantages. In one such implementation, for example, more than five gigabits per second (5 Gbps) throughput may be achievable using a millimeter wavelength frequency for wireless connection 102. In addition the enhanced security and privacy of millimeter wavelength communications may be desirable when wireless docking system 110 is implemented in an environment including other wireless devices and systems in close proximity.

FIG. 1B shows workstation terminal environment 101B and provides a more detailed view of the exemplary wireless docking system 110 of FIG. 1A. The wireless docking system 110 includes wired connections 121, 122, 123, 124, 125, and 126 (hereinafter “wired connections 121-126”), as well as the docking surface 112 and the wireless transceivers 114a1 and 114a2. The wired connections 121-126 can be used to connect the wireless docking system 110 to the devices and features accessible through the workstation environment 101B, such as the resources of the workstation terminal 101A shown in FIG. 1A.

For example, the wired connection 121 may be configured to connect to the monitor 150, in FIG. 1, using a High-Definition Multimedia Interface (HDMI), Digital Visual Interface (DVI), DisplayPort (DP) connector, or any suitable high-speed bus interface. In addition, the wired connection 122 may be configured to provide Universal Serial Bus (USB) connectivity. The wired connection 123 may provide an external Serial Advanced Technology Attachment (e-SATA) interface for connecting to an optical disc drive or other mass storage device of the workstation terminal 101A. Moreover, the wired connection 124 may be designed to provide network connectivity through a local area network (LAN), or through a public packet network such as the Internet. Additionally, the wired connections 125 and 126 may be configured to provide audio and power connections, respectively, to the wireless docking station 110.

Thus, as represented in FIGS. 1A and 1B, the wireless connection 102 established by the wireless transceiver 114a1 enables interoperable use of the portable device 140 and one or more devices of the workstation terminal 101A. Moreover, in one implementation, that interoperability can be further mediated by the wired connections 121-126 linking the wireless docking system 110 to the workstation terminal 110A and its peripheral devices.

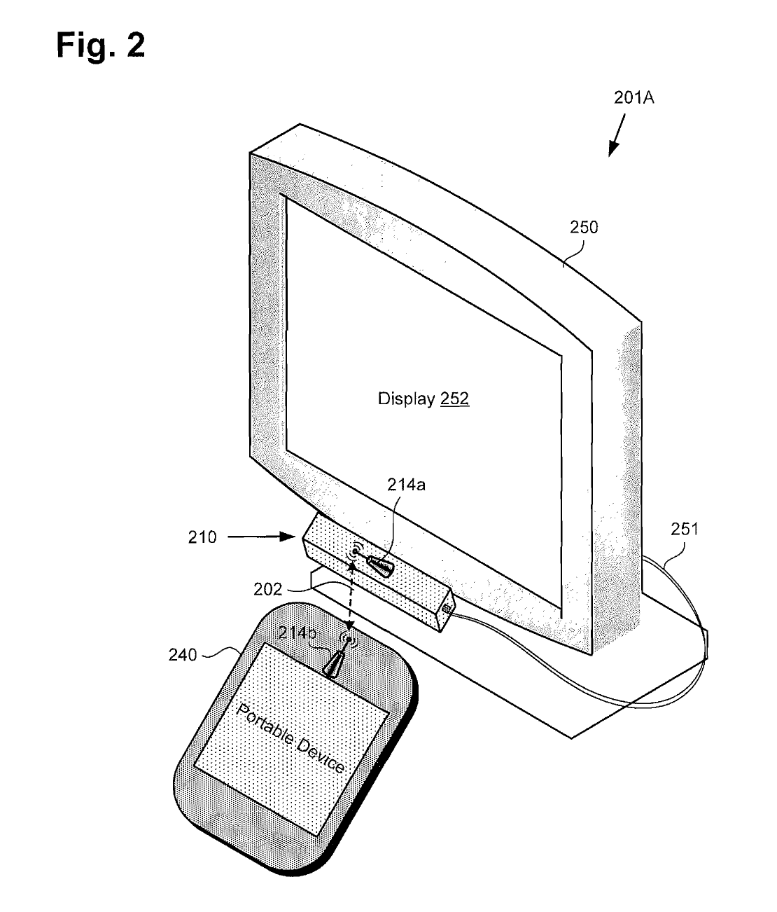

Continuing to FIG. 2, FIG. 2 shows a diagram of a workstation terminal 201A including an exemplary wireless docking system 210, according to another implementation. In addition to the wireless docking system 210, the workstation terminal 201A includes a monitor 250 providing a display 252. The wireless docking system 210 includes a wireless transceiver 214a, and is represented as connected to workstation terminal 201A by means of a high-speed data cable 251, such as an HDMI cable. Also depicted in FIG. 2 is a portable device 240 including a transceiver 214b. The portable device 240 is shown to be in communication with the wireless docking system 210 via a wireless connection 202. The portable device 240, and the workstation terminal 201a including the monitor 250, correspond respectively to the portable device 140 and the workstation terminal 101A including the monitor 150, in FIG. 1A. Moreover, the wireless docking system 210, in FIG. 2, corresponds in general to the wireless docking system 110, in FIG. 1A. Thus, the wireless connection 202, in FIG. 2, may be a millimeter wavelength frequency connection.

In contrast to the implementation shown in FIG. 1A, the wireless docking system 210, in FIG. 2, does not include a docking surface corresponding to the docking surface 112. Instead, according to the implementation of FIG. 2, the wireless docking system 210 takes the form of a dongle type device projecting from a surface of monitor 250. The wireless transceiver 214a of the wireless docking system 210 is configured to establish the wireless connection 202 with the portable device 240 based on the proximity of the portable device 240 and the dongle housing wireless docking system 210.

Although the implementation shown in FIG. 2 depicts the wireless docking system 210 as attached to the monitor 250 of the workstation terminal 201A, that need not be the case in other implementations. For example, workstation terminal 201A may include peripheral devices, such as an additional monitor, a television (TV), a projector, a digital scanner, and/or a printer. As a result, in implementations including those additional peripheral devices, the wireless docking system 210 could be mounted on any conveniently located peripheral device, rather than on the monitor 250, if desired.

According to the implementation shown in FIG. 2, establishment of the wireless connection 202 by the wireless transceiver 214a results in interoperability of the portable device 240 and the workstation terminal 201A. Consequently, the wireless connection 202 may result in interoperability of the portable device 240 and the monitor 250 providing the display 252. As noted above, in one implementation, the portable device 240 may be a tablet computer. More generally however, the portable device 240 may be any portable device or system utilized as a transceiver in modern electronics applications.

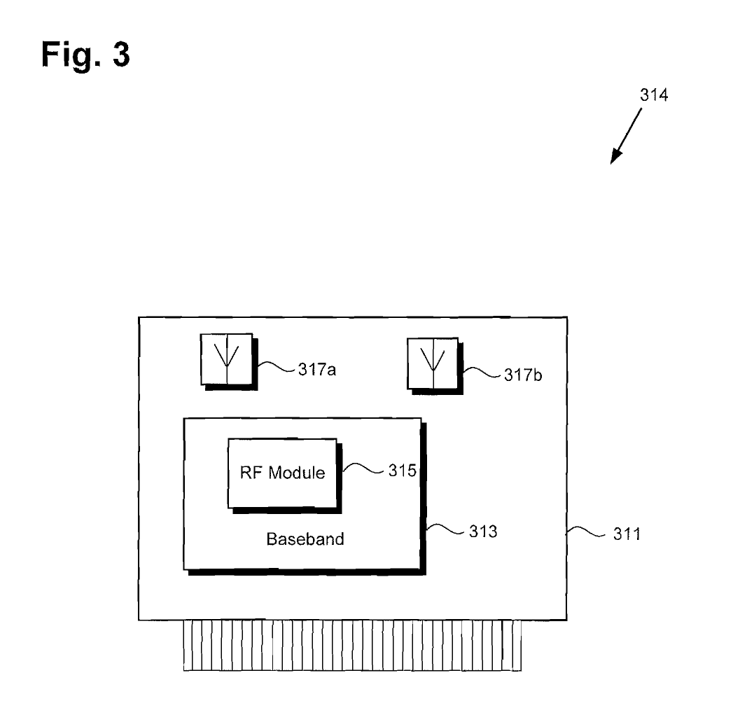

Referring to FIG. 3, FIG. 3 shows an exemplary integrated wireless transceiver 314 implemented as part of a network card 311. The integrated wireless transceiver 314 includes baseband 313, and an RF front-end module 315. It is noted that in some implementations, baseband 313 may take the form of baseband chip 313 having the RF front-end module 315 disposed on the baseband chip. In addition, the integrated wireless transceiver 314 may include one or more antennas 317a and 317b, such as patch antennas, fabricated on the network card 311.

The network card 311 may be a Peripheral Component Interconnect express (PCIe) card, for example, capable of supporting high-speed data transfer. The integrated wireless transceiver 314 corresponds in general to the wireless transceivers 114a1/114a2/114a3/214a and 114b/214b, in FIGS. 1A, 1B, and 2. That is to say, any or all of the wireless transceivers 114a1/114a2/114a3/214a and 114b/214b may be implemented as integrated wireless transceiver 314 including baseband 313 and RF front-end module 315.

In one implementation, the wireless transceiver 114a1/114a2/114a3/214a and/or 114b/214b may be implemented as the integrated wireless transceiver 314 by attaching the network card 311 to a motherboard of the wireless docking station 110/210 and or the portable device 140/240, respectively. It is noted that although the network card 311 is shown to include two antennas, i.e., the antennas 317a and 317b, in other implementations the network card 311 may include more than two antennas. Moreover, in some implementations, a single antenna may be sufficient to support establishment of the wireless connection 102/202 by the integrated wireless transceiver 314. In such implementations, the antennas 317a and 317b may be substituted by a single antenna, such as the antenna 317a.

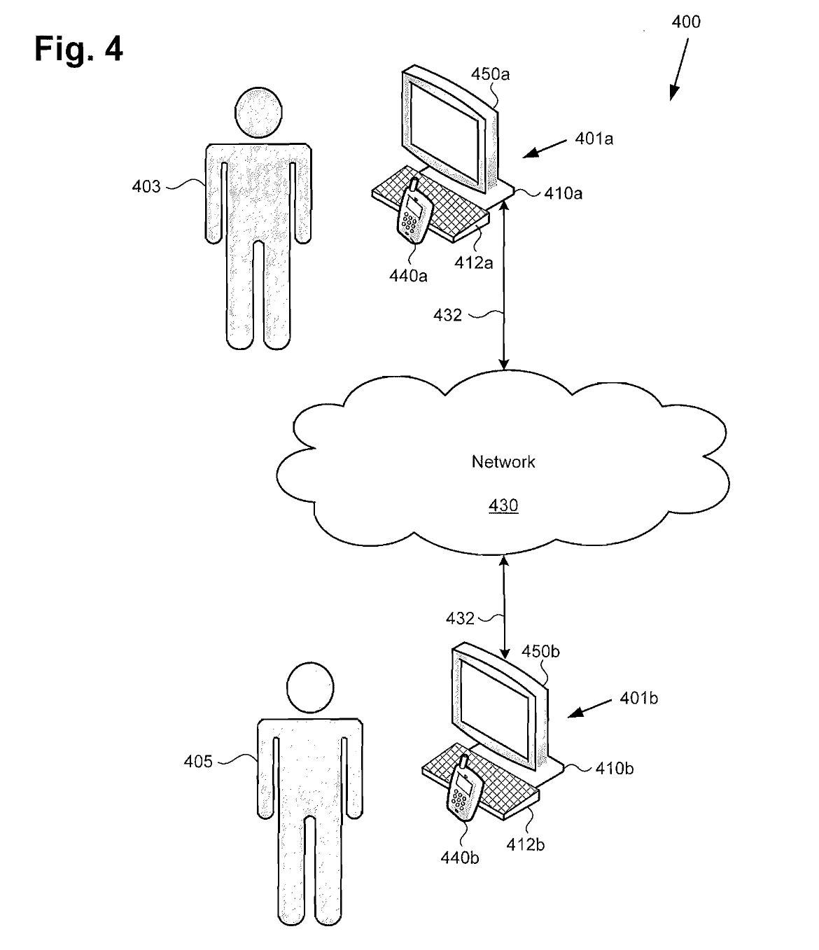

A specific example of the use of a wireless docking system according to the present inventive principles will now be described by reference to FIG. 4. It is emphasized that the specific details being discussed are part of an exemplary implementation, and are provided with such specificity merely as an aid to conceptual clarity. FIG. 4 shows a diagram of a network environment 400 including workstation terminals 401a and 401b connected to exemplary wireless docking systems 410a and 410b, respectively, according to one implementation.

In the network environment 400, a user 403 is in communication with another user 405 via the workstation terminal 401a, a network 430 including network communication links 432, and the workstation terminal 401b. The workstation terminal 401a includes a monitor 450a and is wirelessly connected to a portable device 440a through the wireless docking system 410a including a docking surface 412a. Similarly, the workstation terminal 401b includes a monitor 450b and is wirelessly connected to a portable device 440b through the wireless docking system 410b including a docking surface 412b.

The portable devices 440a and 440b, and the workstation terminals 401a and 401b including the respective monitors 450a and 450b, correspond respectively to the portable device 140/240 and the workstation terminal 101A/201A including the monitor 150/250, in FIGS. 1A and 2. Moreover, the wireless docking systems 410a and 410b correspond to the wireless docking system 110/210, in FIGS. 1A and 2, while the respective docking surfaces 412a and 412b, in FIG. 4, correspond to the docking surface 112, in FIGS. 1A and 1B.

The portable devices 440a and 440b are depicted as mobile telephones. In the implementation shown in FIG. 4, wireless connections established by the wireless docking systems 410a and 410b enable use of the respective portable devices 440a and 440b to communicate over the network 430. Such wireless connections between the wireless docking systems 410a and 410 and the respective portable devices 440a and 440b can be established using wireless transceivers corresponding to the wireless transceivers 114a1/114a2/114a3/214a/314, in FIGS. 1A/1B/2/3.

The network 430 may be a packet network, such as the Internet, for example. In an implementation in which the network 430 corresponds to the Internet, use of the portable devices 440a and 440b to communicate over the network 430 can correspond to use of the portable devices 440a and 440b as Voice over Internet Protocol (VoIP) telephones. Thus, according to the implementation shown in FIG. 4, the interoperability of the portable devices 440a and 440b and the respective workstation terminals 401a and 401b resulting from the wireless connections provided by the respective wireless docking systems 410a and 410b enables use of mobile telephones as VoIP telephones.

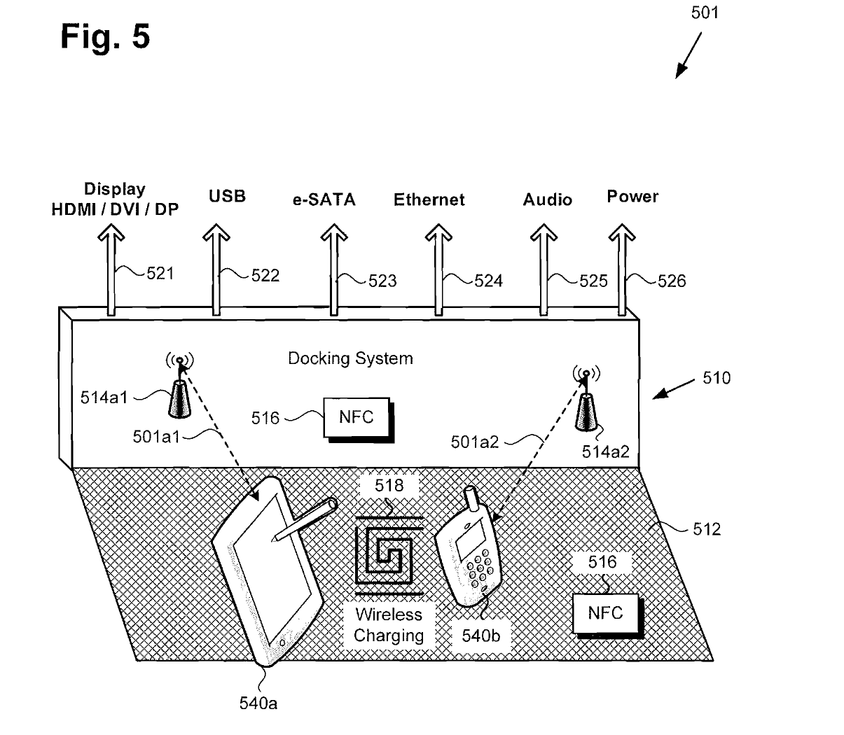

Continuing to FIG. 5, FIG. 5 shows a diagram of another exemplary implementation of a wireless docking system 510. Workstation terminal environment 501 includes the wireless docking system 510 and portable devices 540a and 540b. The wireless docking system 510 includes a docking surface 512 and wired connections 521, 522, 523, 524, 525, and 526 (hereinafter “wired connections 521-526”). The wireless docking system 510 including the docking surface 512 and the wired connections 521-526 corresponds in general to the wireless docking system 110 including the docking surface 112 and the wired connections 121-126, in FIG. 1B. According to the present implementation, the wireless docking system 510 includes multiple wireless transceivers 514a1 and 514a2 for establishing respective multiple wireless connections 502a1 and 502a2 with respective portable devices 540a and 540b. In addition, the wireless docking system 510 includes NFC modules 516 and a wireless charger 518.

The wireless transceivers 514a1 and 514a2 correspond to the wireless transceivers 114a1/114a2/114a3/214a, in FIGS. 1A/1B/2, and may share any of the characteristics previously attributed to that corresponding feature, above. In addition, the wireless connections 502a1 and 502a2 correspond to the wireless connection 102/202 in FIGS. 1A, 1B, and 2. Thus, the wireless transceivers 514a1 and 514a2 may be integrated wireless transceivers corresponding to the integrated wireless transceiver 314, and the wireless connections 502a1 and 502a2 may be millimeter wavelength frequency connections. The transceiver 514a1 may connect to multiple client devices, such as phones 540a and tablets 540b, as depicted by the wireless connections 501a1 and 501a2, respectively.

According to the implementation of FIG. 5, the wireless connections 502a1 and 502a2 enable interoperability of multiple portable devices, e.g., the portable devices 540a and 540b, with one or more other devices connected to the wireless docking system 510. In addition, the wireless charging capability provided by the wireless charger 518 enables charging of the portable devices 540a and 540b through the docking surface 512. Thus, the wireless docking system 510 is configured to charge the portable devices 540a and 540b using the docking surface 512, as well as to utilize the wireless transceivers 514a1 and 514a2 to establish the respective wireless connections 502a1 and 502a2.

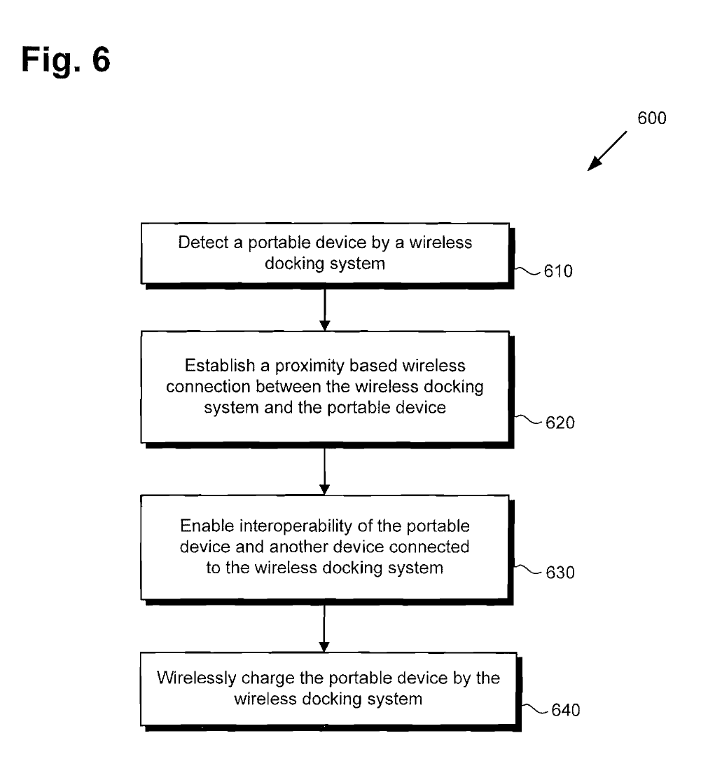

The functionality of the wireless docking system 110/210/510 will now be further described by reference to FIG. 6, which presents flowchart 600 describing an exemplary method for performing wireless docking, according to one implementation. With respect to the method outlined in FIG. 6, it is noted that certain details and features have been left out of flowchart 600 in order not to obscure the discussion of the inventive features in the present application.

Flowchart 600 begins with detecting a portable device 140/240/540a/540b by a wireless docking system 110/210/510 (610). According to the implementation shown in FIGS. 1A, 1B, and 2, detection of the portable device 140/240 may be performed by the wireless docking system 110/210, using wireless transceivers 114a1/114a2/114a3/214a. For example, the wireless transceivers 114a 1/114a2/114a3/214a may be configured to perform a periodic search for discoverable portable devices in the vicinity of the docking surface 112 or the monitor 250. In addition, or alternatively, the implementation shown in FIG. 4 enables use of NFC modules 416 to detect the presence of the portable devices 440a and 440b in the near field vicinity of the docking surface 412.

Flowchart 600 continues with establishing a proximity-based wireless connection 102/202/502a1/502a2 between the wireless docking system 110/210/510 and the portable device 140/240/540a/540b (620). According to the implementations shown in FIGS. 1A, 1B, 2, and 5, the wireless transceivers 114a1/114a2/114a3/214a/514a1/514a2 of the wireless docking system 110/210/510 are configured to establish the wireless connection 102/202/502a1/502a2 with the portable device 140/240/540a/540b based on the proximity of the portable device 140/240/540a/540b and the docking surface 112/412 or the monitor 250. Wireless transceivers 114a1/114a2/114a3/214a/514a1/514a2 may be implemented as the integrated wireless transceiver 314, as noted above. Moreover, as shown in FIG. 5, in at least one implementation, the wireless docking station 510 can be configured to support NFC communications as well.

Referring to FIGS. 1A and 2 in combination with FIG. 6, flowchart 600 continues with enabling interoperability of the portable device 140/240 and another device 101A/201A connected to the wireless docking system 110/210 (630). Establishment of the wireless connection 102/202 by the wireless transceivers 114a1/114a2/114a3/214a (620) results in interoperability of the portable device 140/240 and the workstation terminal 101A/201A. Consequently, the wireless connection 102/202 may result in interoperability of the portable device 140/202 and the monitor 150/250 providing the display 152/252. More generally, the wireless connection 102/202 results in interoperability of the portable device 140/240 and any other device or system connected to the wireless docking system 110/210, such as a keyboard and/or mouse of the workstation terminal 101A/201A. Other examples of devices that may be connected to the wireless docking system 110/210 include a printer, a digital scanner, and a mass storage device. In addition, as discussed above, in one exemplary implementation, interoperability may enable use of the portable device 140/240 as an input device for the workstation terminal 101A/201A.

Referring now to FIG. 5 in combination with FIG. 6, flowchart 600 continues with wirelessly charging the portable device 540a/540b by the wireless docking system 510 (640). Wireless charging of the portable device 540a and/or 540b may be performed using the wireless charger 518 implemented as part of the wireless docking system 510. The wireless charger 518 may be configured to charge the portable device 540a and/or 540b using inductive coupling, or resonant inductive coupling, for example, as known in the art.

Thus, the present application discloses a proximity-based wireless docking system and method. By providing a wireless connection with a portable device, implementations of the solution disclosed by the present application enable wireless docking by substantially any portable device having a radio transceiver, regardless of its form factor. In addition, by enabling interoperability of the portable device with other devices connected through the wireless docking system, the present solution renders the portable device configurable as part of a user's primary productive platform, such as a workstation terminal providing access to network connectivity and/or multiple peripheral devices. Moreover, by utilizing a millimeter wavelength frequency band wireless connection to connect to the wireless docking station, the present solution provides high-throughput, secure, and robust proximity-based wireless connectivity.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A wireless docking system comprising;
a docking surface; and
at least one wireless transceiver configured to establish a wireless connection with a portable device based on a proximity of the portable device and the docking surface;
the wireless connection resulting in interoperability of the portable device and another device connected to the wireless docking system.

2. The wireless docking system of claim 1, wherein the another device is a workstation terminal.

3. The wireless docking system of claim 1, wherein the portable device is a mobile telephone.

4. The wireless docking system of claim 3, wherein the interoperability enables use of the mobile telephone as a Voice over Internet Protocol (VoIP) telephone.

5. The wireless docking system of claim 1, wherein the portable device is one of a laptop computer, a netbook, and a tablet computer.

6. The wireless docking system of claim 1, wherein the wireless connection is established using a millimeter wavelength frequency range.

7. The wireless docking system of claim 1, wherein the wireless transceiver is an integrated wireless transceiver including a baseband chip having an RF front-end module disposed thereon.

8. The wireless docking system of claim 1, wherein the wireless docking system is further configured to charge the portable device using the docking surface.

9. A wireless docking system comprising;
a docking surface; and
an integrated wireless transceiver configured to establish a wireless connection with a portable device based on a proximity of the portable device and the docking surface;
the integrated wireless transceiver including a baseband chip having an RF front-end module disposed thereon;
the wireless connection enabling use of the portable device as an input device for another device connected to the wireless docking system.

10. The wireless docking system of claim 9, wherein the another device is a workstation terminal.

11. The wireless docking system of claim 9, wherein the portable device is a mobile telephone.

12. The wireless docking system of claim 11, wherein use of the mobile telephone as an input device for a workstation terminal connected to the wireless docking system enables use of the mobile telephone as a Voice over Internet Protocol (VoIP) telephone.

13. The wireless docking system of claim 9, wherein the portable device is one of a laptop computer, a netbook, and a tablet computer.

14. The wireless docking system of claim 9, wherein the wireless connection is established using a millimeter wavelength frequency range.

15. The wireless docking system of claim 9, wherein the integrated wireless transceiver further includes at least one patch antenna.

16. The wireless docking system of claim 9, wherein the wireless docking system is further configured to charge the portable device using the docking surface.

17. A method for performing wireless docking, the method comprising:
detecting a portable device by a wireless docking system;
establishing a wireless connection between the wireless docking system and the portable device based on a proximity of the portable device and a docking surface of the wireless docking system;
the wireless connection enabling interoperability of the portable device and another device connected to the wireless docking system.

18. The method of claim 17, wherein the portable device is one of a mobile telephone, a laptop computer, a netbook, and a tablet computer.

19. The method of claim 17, wherein the interoperability enables use of a mobile telephone as a Voice over Internet Protocol (VoIP) telephone.

20. The method of claim 17, further comprising charging the portable device using the docking surface.
